(19) United States
(12) Patent Application Publication
(10) Pub. No.: US 2026/0252757 A1
(43) Pub. Date: Aug. 27, 2026

(54) DYNAMIC-STATIC UNIFIED LOADING PATH DESIGN METHOD FOR TRUE TRIAXIAL MECHANICAL TEST

(71) Applicant: Shenzhen University, Shenzhen (CN)

(72) Inventors: JIANBO ZHU, Shenzhen (CN); ZHUO CEN, Chengdu (CN); HEPING XIE, Beijing (CN); TAO ZHOU, Shenzhen (CN); WEIYUE BAO, Tianjin (CN); SHIWEI ZHANG, Zhoukou (CN); CHENGCHENG XIE, Pu'er (CN); JUNYAN LI, Shenzhen (CN); LINSHENG LIANG, Lianjiang (CN); SILI WANG, Shaoyang (CN); QI HE, Shaoyang (CN); KANGYU WANG, Wenling (CN); KONGWEI ZHANG, Meizhou (CN)

(21) Appl. No.: 19/643,767

(22) Filed: Apr. 9, 2026

(30) Foreign Application Priority Data
Apr. 23, 2025 (CN) 202510516094.6

(51) Int. Cl. G06F 30/17; G06F 119/04

(52) U.S. Cl. CPC G06F 30/17; G06F 2119/04

(57) ABSTRACT

Provided is a dynamic-static unified loading path design method for a true triaxial mechanical test. Loading path design is carried out in a stress space, and a principal stress space is cut into a series of stress meridian plane spaces, thereby transforming a three-dimensional design environment into a two-dimensional design environment; and a design result in the two-dimensional design environment is converted back into a final three-dimensional design result. Distribution of dynamic-static true triaxial mechanical test loading paths within the stress space is designed according to requirements.

### CROSS-REFERENCE TO RELATED APPLICATIONS

This application claims priority to Chinese Patent Application No. 202510516094.6, filed on Apr. 23, 2025, which is hereby incorporated by reference in its entirety.

### TECHNICAL FIELD

The present invention relates to the field of high-end equipment applications, particularly to the domain of mechanical tests, and more particularly to design of loading protocols for static and dynamic true triaxial mechanical tests on solid materials such as rock, concrete, metals, ceramics, and polymers.

### BACKGROUND

True triaxial mechanical test is an important research method for investigating mechanical properties of solid materials. The test can provide a theoretical basis for fields such as geotechnical engineering, mining engineering, concrete structure engineering, and metal processing. In engineering practice, solid materials such as rock and concrete are not only subjected to static loads, but also often affected by various dynamic disturbances. Therefore, results of both static and dynamic true triaxial mechanical tests are of great significance for construction, operation and maintenance of engineering projects. At present, most static true triaxial mechanical test systems are mainly based on the design concept of Mogi-type true triaxial test machine. Three axial loads of the test machine can be independently controlled. In theory, arbitrary loading paths can be realized by regulating stress-time curves of each axial direction.

As shown in FIG. 1, a common loading protocol using the above static true triaxial test system is as follows: first, increase three axial stresses to load the specimen to a certain stress state, maintain second and third principal stresses (σ₂, σ₃) unchanged, and then continue to increase a first principal stress (σ₁) until a stress of the specimen meets test requirements.

This loading path meets the research requirements of most static true triaxial mechanical tests, but is not suitable for dynamic true triaxial mechanical tests, especially dynamic tests with high loading rates or strain rates because it is difficult to achieve precise servo control of dynamic stress during a short dynamic loading process. For example, a dynamic loading duration of a Hopkinson bar test is extremely short (microsecond level), and the typical loading time-history curve is a shock wave with a fixed waveform. Generally, only a pulse width (loading duration) and an amplitude (load magnitude) of the waveform can be adjusted, making it impossible to realize a loading path normally used in traditional static true triaxial mechanical tests.

Therefore, in order to facilitate the research on dynamic true triaxial mechanical tests and realize comparative analysis of dynamic and static mechanical properties of the solid materials, it is necessary to develop a dynamic-static unified loading path design method, so that the designed loading path can be applied not only to dynamic true triaxial test systems, but also to static true triaxial test systems, as well as to dynamic-static coupled true triaxial test systems.

### SUMMARY

In order to solve the problems in the prior art, the present invention provides a dynamic-static unified loading path design method for a true triaxial mechanical test, including:

step 1: in a principal stress space, selecting n₁ Lode angles θ_{σ} and corresponding stress meridian planes within a range of −30° to 30°, setting the stress meridian planes evenly or setting the stress meridian planes unevenly from a customized arrangement; a mathematical expression defining the Lode angle being shown in Formula (1):

$${θ}_{a} = {tan}^{- 1} ( \frac{2 {σ}_{2} - {σ}_{1} - {σ}_{3}}{\sqrt{3} ( {σ}_{1} - {σ}_{3} )} ) \qquad ( 1 )$$

step 2: in the stress meridian plane space selected in step 1, establishing a rectangular plane coordinate system consisting of a p* axis and a q* axis, wherein P* is numerically a multiple of a mean principal stress p, and q* is numerically a multiple of an equivalent stress q, both p* and q* are expressed in unit of MPa, and are calculated as, follows:

$${p}^{*} = \sqrt{3} p = \sqrt{\frac{1}{3}} ( {σ}_{1} + {σ}_{2} + {σ}_{3} )$$

$${q}^{*} = \sqrt{\frac{2}{3}} q = \sqrt{\frac{1}{3} [ {( {σ}_{1} - {σ}_{2} )}^{2} + {( {σ}_{2} - {σ}_{3} )}^{2} + {( {σ}_{3} - {σ}_{1} )}^{2} ]}$$

thus, a combination of coordinates of any point in the stress meridian plane space and the corresponding Lode angle θ_{σ} of the stress meridian plane is also capable of representing a three-dimensional stress state [p*, q*, θ_{σ}];

step 3: dividing regions corresponding to different loading modes in each stress meridian plane space; wherein, the division of various loading mode regions in the stress meridian plane space varies with the change of the corresponding Lode angle θ_{σ};

step 4: arranging n₂ loading paths in each stress meridian plane space, which are specifically represented as rays with a coordinate origin as the endpoint and a slope of k;

step 5: determining a three-dimensional stress state [p*, q*, θ_{σ}] at any point on each loading path according to loading path parameters determined in step 4, which are the Lode angle θ_{σ} corresponding to the stress meridian plane at which the ray is located and the slope k=q*/p* of the ray, wherein the three-dimensional stress state is capable of being transformed into the three-dimensional stress state [σ₁, σ₂, σ₃] expressed in principal stress space coordinates through coordinate transformation and further converted into three-dimensional parameters of the ray in the principal stress space, and a coordinate transformation calculation formula is as shown Formula (2),

$$[ \begin{matrix}{σ}_{1} \\ {σ}_{2} \\ {σ}_{3}\end{matrix} ] = [ \begin{matrix}\sqrt{1 / 2} & - \sqrt{1 / 6} & \sqrt{1 / 3} \\ 0 & \sqrt{2 / 3} & \sqrt{1 / 3} \\ - \sqrt{1 / 2} & - \sqrt{1 / 6} & \sqrt{1 / 3}\end{matrix} ] \cdot [ \begin{matrix}{q}^{*} / \sqrt{1 + {tan}^{2} {θ}_{σ}} \\ {q}^{*} tan {θ}_{σ} / \sqrt{1 + {tan}^{2} {θ}_{σ}} \\ {p}^{*}\end{matrix} ] \qquad ( 2 )$$

then, normalizing the three-dimensional stress state [σ₁, σ₂, σ₃] according to σ₃, thus obtaining a ratio Δσ₁:Δσ₂Δσ₃ of synchronous stress increments along three principal stress axes corresponding to each loading path; and

step 6: by integrating the above design process, completing the design of a total of N=n₁×n₂ dynamic-static universal loading paths for the true triaxial mechanical test of tested materials.

As a further improvement of the present invention, in step 1, in the principal stress space, n₁ Lode angles θ_{σ} and corresponding stress meridian planes are selected within the range of −30° to 30°, and the stress meridian planes are set to be arranged evenly or unevenly.

As a further improvement of the present invention, in step 3, the different loading modes include triaxial compression, triaxial extension, and tension-compression composite; wherein, a region corresponding to the triaxial compression loading mode is specifically a region enclosed by a ray starting from an origin in a first quadrant and a positive half-axis of the p* axis; a region corresponding to the triaxial extension loading mode is specifically a region enclosed by a ray starting from an origin in a second quadrant and a negative half-axis of the p* axis; and a region corresponding to the tension-compression composite loading mode is a region between the region corresponding to the triaxial compression loading mode and the region corresponding to the triaxial extension loading mode.

As a further improvement of the present invention, in step 3, a slope k of a boundary line between the triaxial compression loading region and the tension-compression composite loading region decreases with the increase of the Lode angle θ_{σ}, and the slope k here is a positive value, so that a range of the triaxial compression loading region is continuously reduced; a slope k of a boundary line between the triaxial extension loading region and the tension-compression composite loading region decreases with the increase of the Lode angle θ_{σ}, and the slope k here is a negative value, so that a range of the triaxial extension loading region is continuously increased; and the variation of the tension-compression composite loading region is determined according to the variations of the above two regions.

As a further improvement of the present invention, in step 4, n₂ loading paths are arranged in each stress meridian plane, specifically by selecting n₂ rays starting from the coordinate origin with a slope of kᵢ, and the rays are the dynamic-static universal loading paths.

As a further improvement of the present invention, in step 6, the design of a total N=n₁×n₂ dynamic-static universal loading paths for the true triaxial mechanical test is completed.

The present invention has the beneficial effects that:

The loading path design method provided by the present invention has the advantages as follows:

Innovation point 1: the method enables comparability between the results of the dynamic and static true triaxial mechanical tests. Based on the features of high strain rates and load time-history curves from dynamic true triaxial Hopkinson bar tests, a loading path design method suitable for both dynamic and static true triaxial tests is established, achieving comparability between the results of the dynamic and static tests.

As shown in FIG. 7, the dynamic and static true triaxial mechanic loading paths are the same ray in the stress space by controlling the ratio Δσ₁:Δσ₂:Δσ₃ of synchronous increments of three axial stresses.

Innovation point 2: the distribution of the loading paths of the dynamic and static true triaxial mechanical tests in the stress space can be designed as required. The loading path design is carried out in the stress space. In the design process of the loading paths, a visualization method of stress space is used, and the coordinate transformation formula of the three-dimensional stress state [p*, q*, θ_{σ}] in the stress meridian plane and the three-dimensional stress state [σ₁, σ₂, σ₃] in the principal stress space is given, and the principal stress space is cut into a set of series meridian stress plane spaces to realize the transformation from the three-dimensional design environment to the two-dimensional design environment. Based on the above two-dimensional design environment, the dynamic-static unified loading paths under different loading modes (triaxial compression, triaxial tension and tension-compression composite) are designed respectively. The design result in the two-dimensional design environment is converted into the final three-dimensional design result, that is, the ratio Δσ₁:Δσ₂:Δσ₃ of synchronous increments of the three axial stresses.

As shown in FIG. 8, by tuning the ratio Δσ₁:Δσ₂:Δσ₃ of synchronous increments of the three axial stresses, the directions and a distribution density of multiple loading paths in the stress space in the dynamic and static true triaxial mechanical test can be adjusted. Furthermore, an experimental basis for simulating the stress state and the loading path of engineering objects under complex static load and dynamic disturbance is provided.

### BRIEF DESCRIPTION OF THE DRAWINGS

FIG. 1 is a schematic diagram of a common loading protocol in static true triaxial test research, including stress-time curves of two static loading paths and loading paths in a principal stress space thereof;

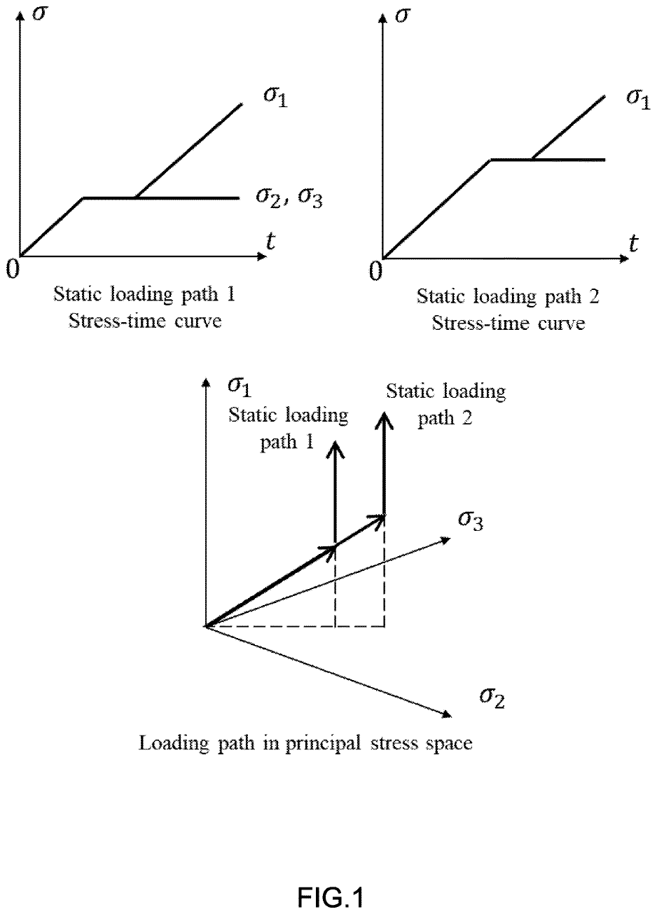

FIG. 2 is a schematic diagram of loading a cubic specimen in static and dynamic true triaxial tests;

FIG. 3 is a schematic diagram of stress meridian plane corresponding to different Lode angles θ_{σ} and stress deviatoric plane in the principal stress space;

FIG. 4 is a schematic diagram showing the division of different loading modes in the stress meridian plane;

FIG. 5 is a schematic diagram of designing loading paths on the stress meridian plane corresponding to the Lode angles θ_{σ}=0° in the principal stress space;

FIG. 6 is a schematic diagram of a dynamic-static unified loading solution for a true triaxial mechanical test, including a stress-time curve of one dynamic loading path, a stress-time curve of one static loading path and the corresponding loading paths in the principal stress space, and the loading paths are in the form of rays by controlling synchronous increment of three dynamically and statically loaded axial stresses;

FIG. 7 is a schematic diagram of a dynamic-static universal loading solution for a true triaxial mechanical test, including a stress-time curve of one dynamic loading path, a stress-time curve of one static loading path and the corresponding loading path in the principal stress space, and the loading paths are the same ray in the principal stress space by controlling synchronous increment of the three dynamically and statically loaded axial stresses according to the same ratio Δσ₁:Δσ₂:Δσ₃;

FIG. 8 is a schematic diagram of a dynamic-static unified loading protocol for a true triaxial mechanical test, including 2 groups of loading paths with different directions and distribution densities;

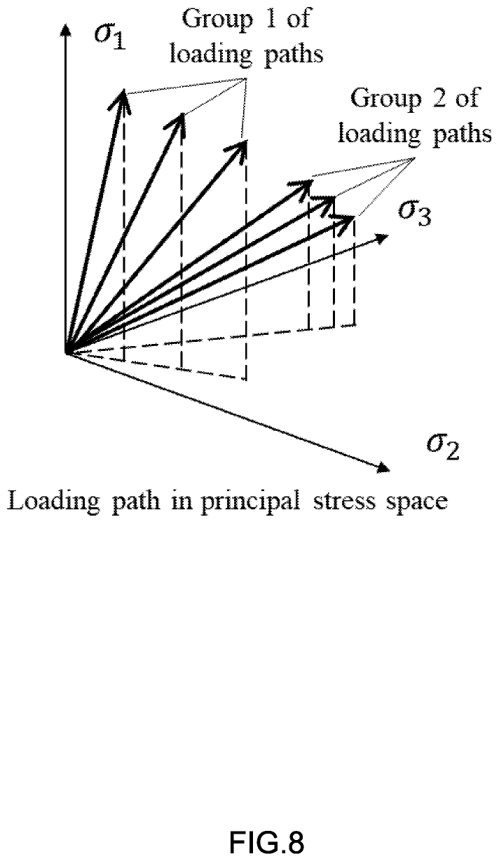

FIG. 9 shows distribution of three loading paths on the stress meridian plane corresponding to the Lode angle θ_{σ}=0° designed in the embodiment;

FIG. 10 shows results of a stress-time curve of a verification test for the loading path with the Lode angle θ_{σ}=0° and Δσ₁:Δσ₂:Δσ₃=13.02:7.01:1.00 designed in the embodiment;

FIG. 11 shows a test verification result for the loading path on the stress meridian plane with the Lode angle and θ_{σ}=0° and Δσ₁:Δσ₂:Δσ₃=13.02:7.01:1.00 meridian designed in the embodiment; and

FIG. 12 shows a test verification result for three loading paths on the stress meridian plane corresponding to the Lode angle θ_{σ}=0° designed in the embodiment.

### DESCRIPTION OF EMBODIMENTS

The specific embodiments of the present invention will be described in further detail with reference to the drawings and examples hereinafter. The following embodiments are used to illustrate the present invention, but are not used to limit the scope of the present invention.

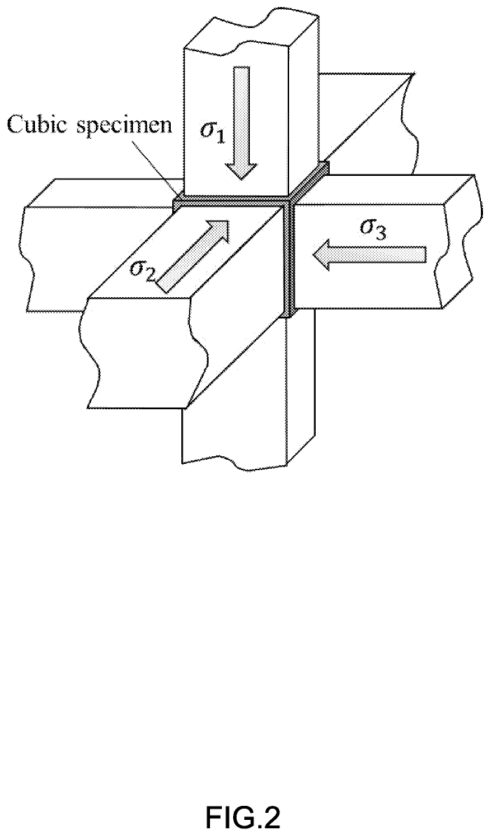

As shown in FIG. 2, the embodiments of the present invention take a pre-test of dynamic triaxial compression strength of sandstone as an example, with compressive stress defined as positive throughout the embodiment. A testing device is a dynamic true triaxial test system based on a Hopkinson Pressure Bar. A loading mode is that three axes are applied with impact stress waves through square section waveguide bars, and titanium alloy cube specimens which is of the same material as the waveguide bars are used for pre-test to verify a feasibility of the designed loading path.

By adopting the dynamic-static unified loading path design method for the true triaxial mechanical test, an implementation process of designing the loading protocol is as follows.

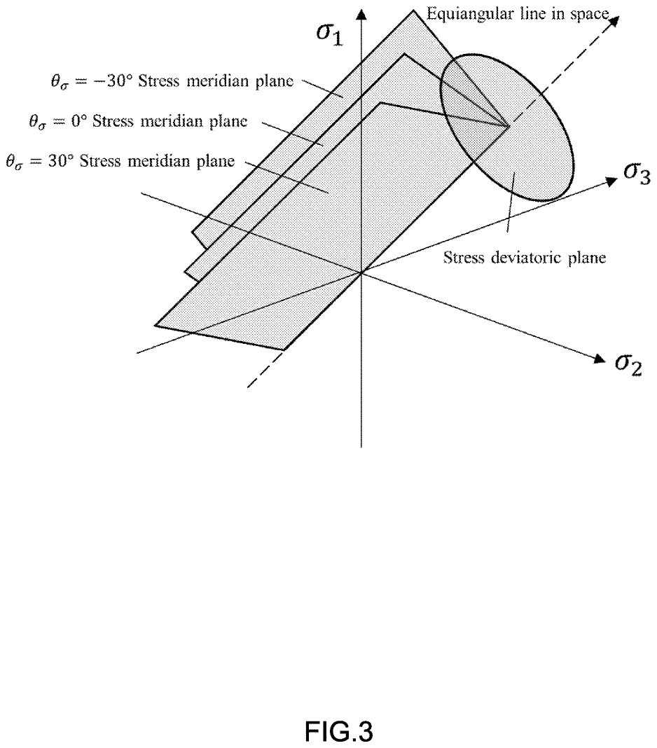

At step 1, as shown in FIG. 3, in a principal stress space, one equiangular line is determined, which passes through an origin of coordinates and forms equal angles with three coordinate axes. Any plane perpendicular to the equiangular line is a stress deviatoric plane, and any plane perpendicular to the stress deviatoric plane and containing the equiangular line is a stress meridian plane, and the stress meridian plane containing the coordinate axis σ₁ corresponds to Lode angle θ_{σ}=−30°. It should be noted that a mathematical expression defining the Lode angle is shown in Formula (1). three Lode angles θ_{σ} and corresponding stress meridian planes are selected within a range of −30° to 30°, and the stress meridian planes are set to be distributed evenly, that is, an interval of the Lode angles corresponding to the adjacent meridian planes is 30 degrees (θ_{σ}=−30°, θ_{σ}=0°, θ_{σ}, =30°)

$${θ}_{a} = {tan}^{- 1} ( \frac{2 {σ}_{2} - {σ}_{1} - {σ}_{3}}{\sqrt{3} ( {σ}_{1} - {σ}_{3} )} ) \qquad ( 1 )$$

At step 2, in the three stress meridian plane spaces selected in step 1, a rectangular plane coordinate system consisting of a p* axis and a q* axis is established, wherein P* is numerically a multiple of a mean principal stress p, and q* is numerically a multiple of an equivalent stress (or generalized shear stress) q, both p* and q* are expressed in unit of MPa, and are calculated as follows:

$${p}^{*} = \sqrt{3} p = \sqrt{\frac{1}{3}} ( {σ}_{1} + {σ}_{2} + {σ}_{3} )$$

$${q}^{*} = \sqrt{\frac{2}{3}} q = \sqrt{\frac{1}{3} [ {( {σ}_{1} - {σ}_{2} )}^{2} + {( {σ}_{2} - {σ}_{3} )}^{2} + {( {σ}_{3} - {σ}_{1} )}^{2} ]}$$

Thus, a combination of coordinates of any point in the stress meridian plane space and the corresponding Lode angle θ_{σ} of the stress meridian plane is also capable of representing a three-dimensional stress state [p*, q&,θ_{σ}].

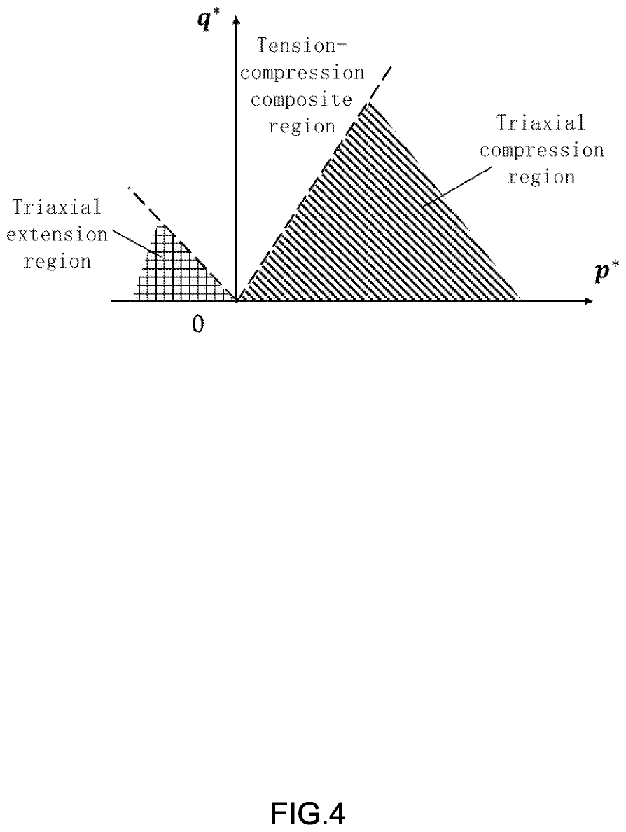

At step 3, as shown in FIG. 4, regions corresponding to different loading modes (triaxial compression, triaxial extension and tension-compression composite) are divided in each stress meridian plane space; wherein, the region corresponding to the triaxial compression loading mode is specifically a region enclosed by a ray starting from an origin in a first quadrant and a positive axis of the p* axis; wherein, the loading mode regions in the stress meridian plane space varies with the change of the corresponding Lode angle θ_{σ}, for example, a slope k of a boundary line between the triaxial compression loading region and the tension-compression composite loading region decreases with the increase of the Lode angle θ_{σ}, so a range of the triaxial compression loading region is reduced accordingly. Taking the stress meridian plane corresponding to the Lode angle θ_{σ}=0° as an example, the region corresponding to the triaxial compression loading mode is a region enclosed by a ray starting from an origin in a first quadrant and a positive half-axis of the p* axis.

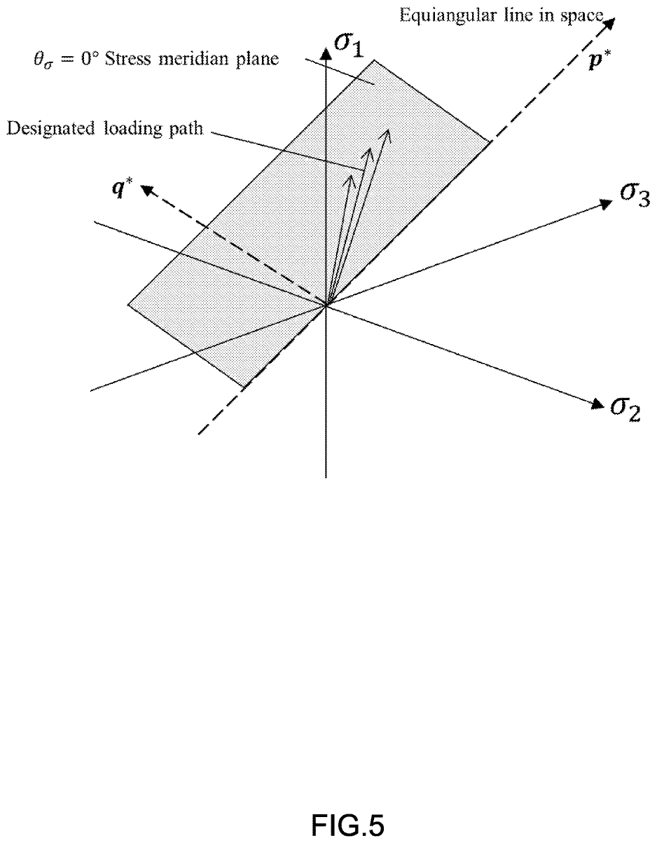

At step 4, as shown in FIG. 5, three loading paths are disposed in the region corresponding to the triaxial compression loading mode in each stress meridian plane, specifically, three rays starting from the origin of the coordinates and with a slope of kᵢ(i=1,2,3) are selected, and these rays are dynamic-static unified loading paths. Taking the stress meridian plane corresponding to the Lode angle θ_{σ}=0° as an example, the slopes of the three selected rays are respectively 0.40, 0.55 and 0.70, which are all smaller than \sqrt{⅔}, thus belong to the region of the triaxial compression loading mode.

At step 5, nine loading paths are determined in total in the above step 4, each of which corresponds to a Lode angle θ_{σ} and the slope k=q*/p* of the ray in the stress meridian plane space, so that the three-dimensional stress state [p*, q*, θ_{σ}] at any point in each loading path can be determined, which may be transformed into the three-dimensional stress state expressed in principal stress space coordinates through coordinate transformation, and a coordinate transformation calculation formula is as shown Formula (2). Then, the three-dimensional stress state [σ₁, σ₂, σ₃] is normalized according to σ₃, thus obtaining a ratio Δσ₁:Δσ₂:Δσ₃ of synchronous stress increment along three principal stress axes corresponding to each loading path. As shown in Table 1, Table 1 shows the results of normalizing after calculation through the Formula (2).

$$[ \begin{matrix}{σ}_{1} \\ {σ}_{2} \\ {σ}_{3}\end{matrix} ] = [ \begin{matrix}\sqrt{1 / 2} & - \sqrt{1 / 6} & \sqrt{1 / 3} \\ 0 & \sqrt{2 / 3} & \sqrt{1 / 3} \\ - \sqrt{1 / 2} & - \sqrt{1 / 6} & \sqrt{1 / 3}\end{matrix} ] \cdot [ \begin{matrix}{q}^{*} / \sqrt{1 + {tan}^{2} {θ}_{σ}} \\ {q}^{*} tan {θ}_{σ} / \sqrt{1 + {tan}^{2} {θ}_{σ}} \\ {p}^{*}\end{matrix} ] \qquad ( 2 )$$

Taking the design of the loading path with the Lode angle θ_{σ}=0° and a slope of k=0.70 as an example, a stress state point on the loading path that satisfies p*=100 MPa is selected, q*=70 MPa is calculated according to the slope, and substituted into the formula to calculate the three-dimensional stress state [σ₁, σ₂, σ₃] expressed in principal stress space coordinates, and obtain that the stress state of the point is expressed as [σ₁, σ₂, σ₃]=[107.2325, 57.7350, 8.2376] MPa. then the stress state is normalized to obtain a ratio Δσ₁:Δσ₂: Δσ₃=13.02:7.01:1.00 of synchronous stress increment.

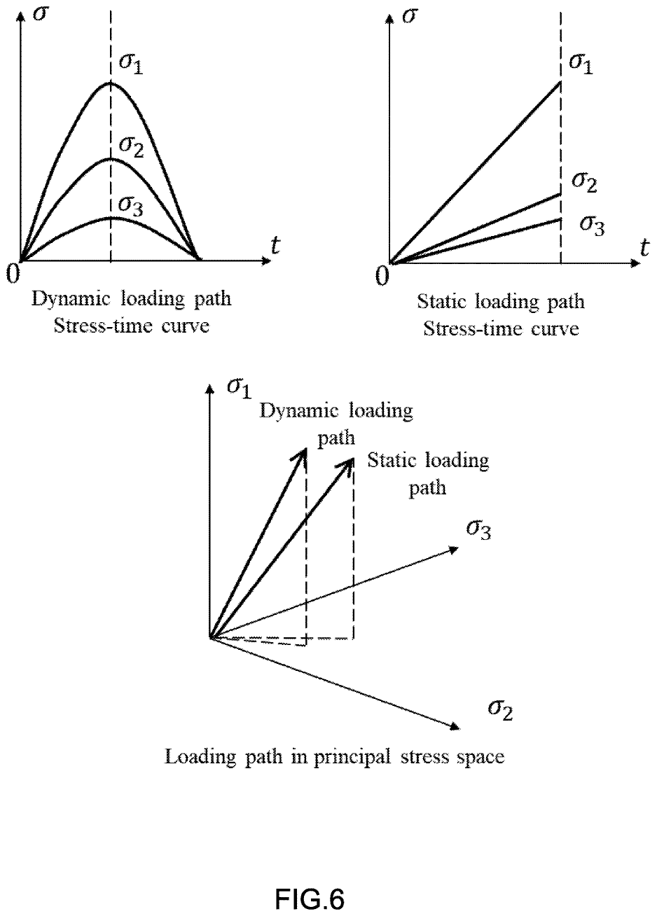

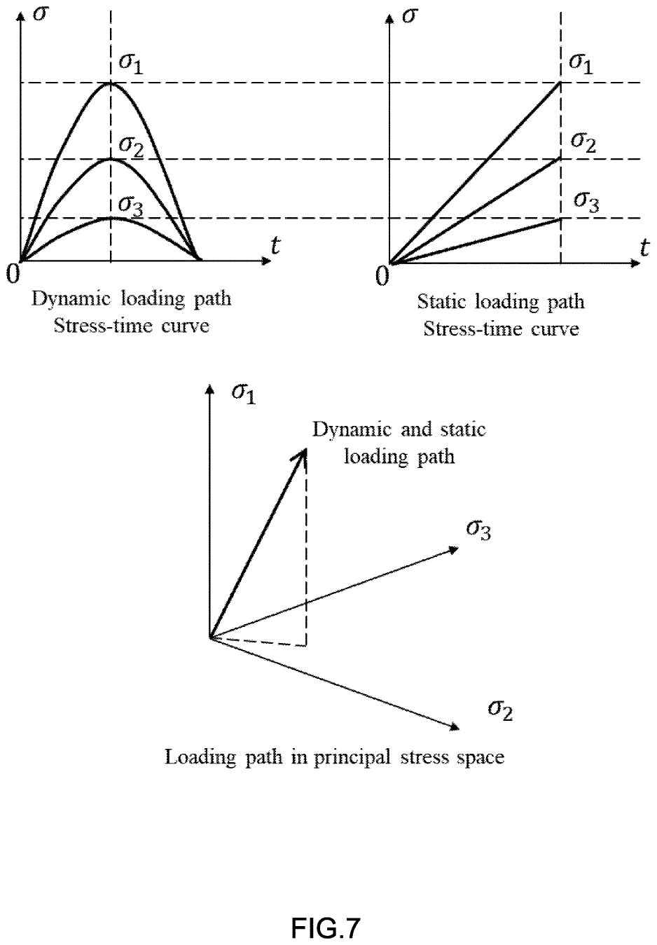

As shown in FIG. 6 and FIG. 7, firstly, the design method changes an amplitude of the stress-time curve while keeps a shape of the stress-time curve unchanged, that is, controls the three axial stresses to increase synchronously during the loading process, so as to realize that the dynamic and static loading paths are in the form of rays in the stress space (the principal stress space and the stress meridian plane space) (as shown in FIG. 6). When loading is carried out in the dynamic and static true triaxial mechanical test according to the same ratio Δσ₁:Δσ₂: Δσ₃, the loading path in the principal stress space and the stress meridian plane space is the same ray, that is, the static and dynamic loading is under the same loading path (as shown in FIG. 7). Secondly, the design method adjusts the distribution of the loading paths in the stress space (the principal stress space and the stress meridian plane space) by controlling the ratio of synchronous stress increment along three principal stress axes during the loading process, that is, the direction in which the above rays extend in the stress space. The final design result of the method is the ratio of the synchronous stress increment along the three principal stress axes during the loading process of the dynamic and static true triaxial mechanical tests, which is expressed by Δσ₁:Δσ₂: Δσ₃. Each ratio corresponds to one specific loading path in the stress space.

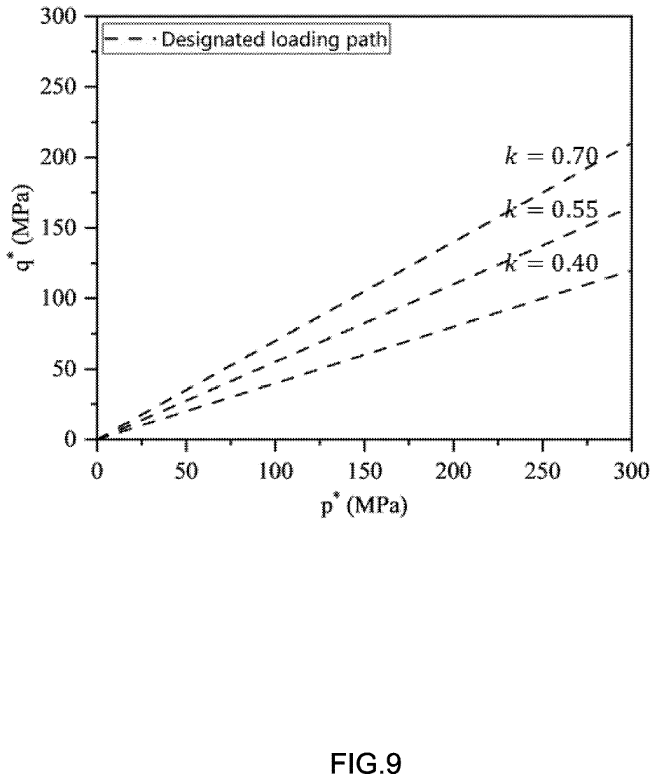

At step 6, through the above design process, the design of nine dynamic-static unified loading paths for the true triaxial mechanical pre-test of sandstone is completed, wherein the nine loading paths are respectively distributed on three stress meridian planes corresponding to the Lode angles θ_{σ}=−30°, θ_{σ}=0°, θ_{σ}=30° and the distribution of the three loading paths on the stress meridian plane corresponding to the Lode angle θ_{σ}=0° are shown in FIG. 9.

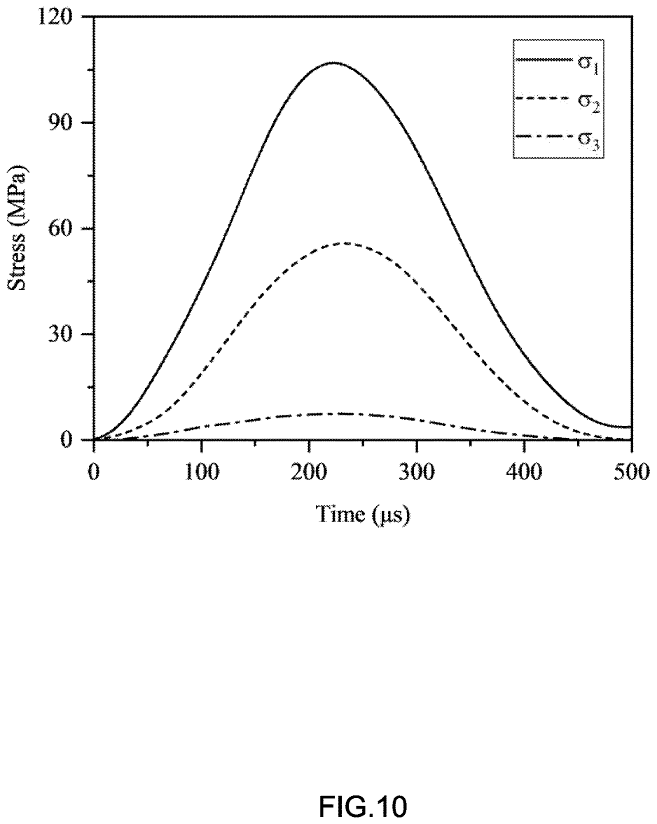

At step 7, taking a design result in the stress meridian plane corresponding to the Lode angle θ_{σ}=0° as an example, an incident stress amplitude of a Hopkinson bar is adjusted according to the designed loading path. Taking the loading path with Lode angle θ_{σ}=0° and k=0.70 as an example, stress-time curves of sample are controlled to be identical and the ratio of synchronous stress increase increment along three principal stress axes is controlled to be 13.02:7.01:1.00, as shown in FIG. 10.

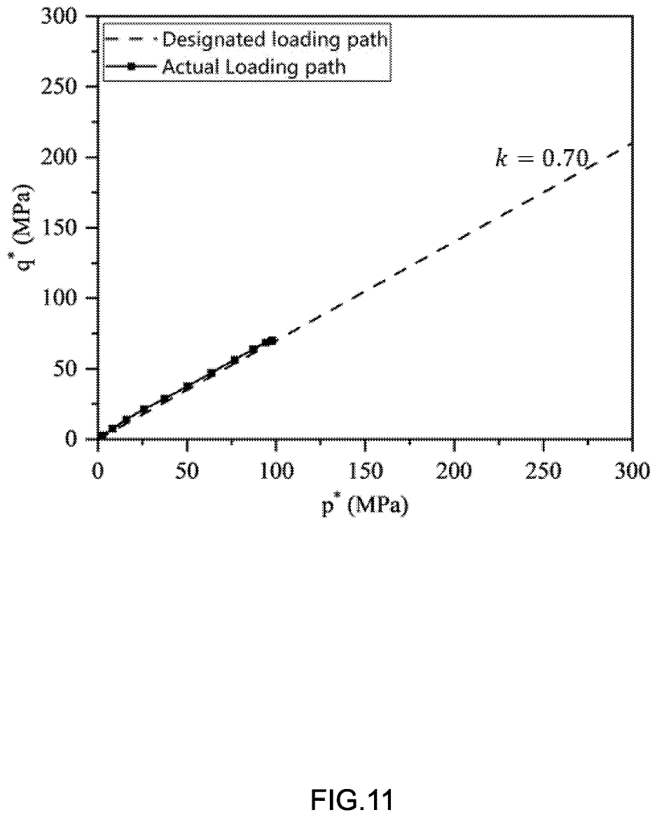

Thus, the stress in each principal stress axis increases synchronously according to the design ratio Δσ₁:Δσ₂: Δσ₃, and a dynamic stress state of a titanium alloy specimen moves along the ray corresponding to the loading path in the stress meridian plane and the principal stress space, as shown in FIG. 11.

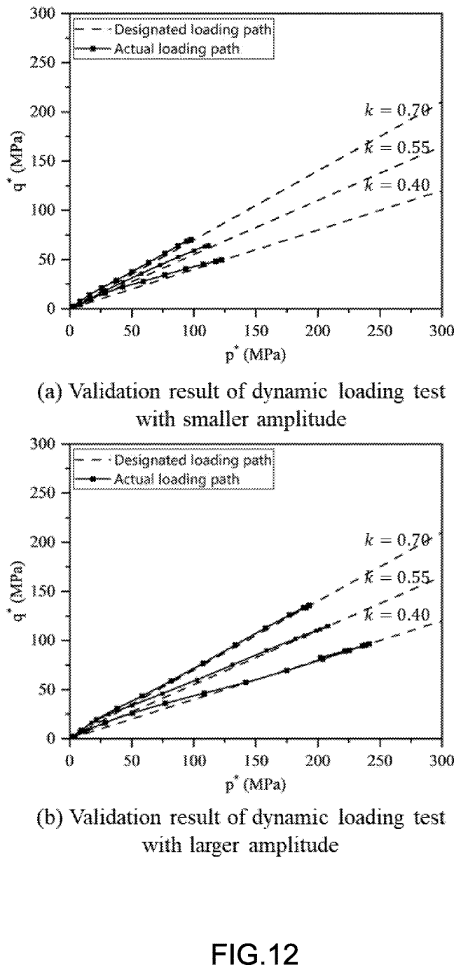

The tests of three loading paths in the stress meridian plane corresponding to the Lode angle θ_{σ}=0° under smaller and larger amplitude dynamic loads are completed, which verifies the feasibility of the dynamic-static unified loading paths designed by the method, as shown in FIG. 12.

To sum up, the loading path design is carried out in the stress space, and the principal stress space is cut into a set of series meridian stress plane spaces to realize the transformation from the three-dimensional design environment to the two-dimensional design environment. Based on the above two-dimensional design environment, the dynamic-static unified loading paths under three different loading modes, which are triaxial compression, triaxial tension and tension-compression composite, are designed respectively. The design result in the two-dimensional design environment is transformed into the final three-dimensional design result, that is, the ratio Δσ₁:Δσ₂: Δσ₃ of the synchronous increment of the three axial stresses.

TABLE 1
Design results of dynamic-static universal loading
path for true triaxial mechanical test

| Lode angle θ_{σ} | k = q*/p* | Δσ₁:Δσ₂:Δσ₃ |
|---|---|---|
| −30° | 0.70 | 3.94:1.00:1.00 |
| | 0.90 | 6.25:1.00:1.00 |
| | 1.10 | 11.5:1.00:1.00 |
| 0° | 0.40 | 2.92:1.96:1.00 |
| | 0.55 | 5.13:3.06:1.00 |
| | 0.70 | 13.02:7.01:1.00 |
| 30° | 0.40 | 2.95:2.95:1.00 |
| | 0.50 | 4.62:4.62:1.00 |
| | 0.60 | 9.40:9.40:1.00 |

The foregoing are further detailed descriptions of the present invention with reference to the specific preferred embodiments, and it should not be considered that the embodiments of the present invention are limited to these descriptions. For those having ordinary skills in the art, some simple deduction or replacement can be made without departing from the concept of the present invention, which shall all be included within the scope of protection of the present invention.

What is claimed is:

1. A dynamic-static universal loading path design method for a true triaxial mechanical test, comprising:
step 1: in a principal stress space, selecting n₁ Lode angles θ_{σ} and corresponding stress meridian planes within a range of −30° to 30°, setting the stress meridian planes evenly or setting the stress meridian planes unevenly from a customized arrangement; a mathematical expression defining the Lode angle being shown in Formula (1):
$${θ}_{a} = {tan}^{- 1} ( \frac{2 {σ}_{2} - {σ}_{1} - {σ}_{3}}{\sqrt{3} ( {σ}_{1} - {σ}_{3} )} ) \qquad ( 1 )$$
step 2: in the stress meridian plane space selected in step 1, establishing a rectangular plane coordinate system consisting of a axis p* and a q* axis, wherein p* is numerically a multiple of a mean principal stress p, and q* is numerically a multiple of an equivalent stress q, both p* and q* are expressed in unit of MPa, and are calculated as follows:
$${p}^{*} = \sqrt{3} p = \sqrt{\frac{1}{3}} ( {σ}_{1} + {σ}_{2} + {σ}_{3} )$$
$${q}^{*} = \sqrt{\frac{2}{3}} q = \sqrt{\frac{1}{3} [ {( {σ}_{1} - {σ}_{2} )}^{2} + {( {σ}_{2} - {σ}_{3} )}^{2} + {( {σ}_{3} - {σ}_{1} )}^{2} ]}$$
thus, a combination of the coordinates of any point in the stress meridian plane space and the corresponding Lode angle θ_{σ} of the stress meridian plane is also capable of representing a three-dimensional stress state [p*, q*, θ_{σ}];
step 3: dividing regions corresponding to different loading modes in each stress meridian plane space; wherein, the division of various loading mode regions in the stress meridian plane space varies with the change of the corresponding Lode angle θ_{σ};
step 4: arranging n₂ loading paths in each stress meridian plane space, which are specifically represented as rays with a coordinate origin as the endpoint and a slope of k;
step 5: determining a three-dimensional stress state [p*, q*, θ_{σ}] at any point on each loading path according to loading path parameters determined in step 4, which are the Lode angle θ_{σ} corresponding to the stress meridian plane at which the ray is located and the slope k=q*/p* of the ray, wherein the three-dimensional stress state is capable of being transformed into the three-dimensional stress state [σ₁, σ₂, σ₃] expressed in principal stress space coordinates through coordinate transformation and further converted into three-dimensional parameters of the ray in the principal stress space, and a coordinate transformation calculation formula is as shown Formula (2),
$$[ \begin{matrix}{σ}_{1} \\ {σ}_{2} \\ {σ}_{3}\end{matrix} ] = [ \begin{matrix}\sqrt{1 / 2} & - \sqrt{1 / 6} & \sqrt{1 / 3} \\ 0 & \sqrt{2 / 3} & \sqrt{1 / 3} \\ - \sqrt{1 / 2} & - \sqrt{1 / 6} & \sqrt{1 / 3}\end{matrix} ] \cdot [ \begin{matrix}{q}^{*} / \sqrt{1 + {tan}^{2} {θ}_{σ}} \\ {q}^{*} tan {θ}_{σ} / \sqrt{1 + {tan}^{2} {θ}_{σ}} \\ {p}^{*}\end{matrix} ] \qquad ( 2 )$$
then, normalizing the three-dimensional stress state [σ₁, σ₂, σ₃] according to σ₃, thus obtaining a ratio Δσ₁:Δσ₂: Δσ₃ of synchronous stress increments along three principal stress axes corresponding to each loading path; and
step 6: by integrating the above steps, completing the design of a total of N=n₁×n₂ dynamic-static universal loading paths for the true triaxial mechanical test of tested materials.

2. The dynamic-static universal loading path design method for the true triaxial mechanical test according to claim 1, wherein in step 1, in the principal stress space, n₁ Lode angles θ_{σ} and corresponding stress meridian planes are selected within the range of −30° to 30°, and the stress meridian planes are set to be arranged evenly or unevenly.

3. The dynamic-static universal loading path design method for the true triaxial mechanical test according to claim 2, wherein in step 3, the different loading modes comprise triaxial compression, triaxial extension, and tension-compression composite; wherein, a region corresponding to the triaxial compression loading mode is specifically a region enclosed by a ray starting from an origin in a first quadrant and a positive half-axis of the p* axis; a region corresponding to the triaxial extension loading mode is specifically a region enclosed by a ray starting from an origin in a second quadrant and a negative half-axis of the p* axis; and a region corresponding to the tension-compression composite loading mode is a region between the region corresponding to the triaxial compression loading mode and the region corresponding to the triaxial extension loading mode.

4. The dynamic-static universal loading path design method for the true triaxial mechanical test according to claim 3, wherein in step 3, a slope k of a boundary line between the triaxial compression loading region and the tension-compression composite loading region decreases with the increase of the Lode angle, θ_{σ}, and the slope k here is a positive value, so that a range of the triaxial compression loading region is continuously reduced; a slope k of a boundary line between the triaxial extension loading region and the tension-compression composite loading region decreases with the increase of the Lode angle θ_{σ}, and the slope k here is a negative value, so that a range of the triaxial extension loading region is continuously increased; and the variation of the tension-compression composite loading region is determined according to the variations of the above two regions.

5. The dynamic-static universal loading path design method for the true triaxial mechanical test according to claim 4, wherein in step 4, n₂ loading paths are arranged in each stress meridian plane, specifically by selecting n₂ rays starting from the coordinate origin with a slope of kₗ, and the rays are the dynamic-static universal loading paths.

6. The dynamic-static universal loading path design method for the true triaxial mechanical test according to claim 5, wherein in step 6, the design of a total of N=n₁×n₂ dynamic-static universal loading paths for the true triaxial mechanical test of the tested sandstone is completed.
